(19) United States
(12) Patent Application Publication
(10) Pub. No.: US 2016/0157410 A1
(43) Pub. Date: Jun. 9, 2016

(54) DEEP RIPPER

(71) Applicants: Loran BALVANZ, Eldora, IA (US); Dean BIGELOW, St. Brieux (CA)

(72) Inventors: Loran BALVANZ, Eldora, IA (US); Dean BIGELOW, St. Brieux (CA)

(21) Appl. No.: 14/958,276

(22) Filed: Dec. 3, 2015

Related U.S. Application Data
(60) Provisional application No. 62/088,168, filed on Dec. 5, 2014.

(51) Int. Cl. A01B 15/02

(52) U.S. Cl. CPC A01B 15/025

(57) ABSTRACT

The present invention comprises a ripper used penetrate and break up soil that includes a leading edge configured to decrease wear and reduce drag, while providing superior performance. The ripper is comprised of a main body, a top cap, a wing, and a bracket.

### RELATED APPLICATION

The present application claims priority to and incorporates by reference U.S. Provisional Patent Application No. 62/088,168 filed on Dec. 5, 2014.

### BACKGROUND OF THE INVENTION

1. Field

The present invention relates to a ground engagement or soil tillage tool. In particular, the invention comprises a ripper used penetrate and break up soil that includes a leading edge configured to decrease wear and reduce drag, while providing superior performance.

2. Background

Rippers are devices used with various types of equipment to engage with the ground for the purpose of fracturing, breaking up, and mixing the soil. Rippers are commonly used in agricultural and construction settings to engage soils for a variety of purposes. Rippers typically are attached to the end of tines and then are towed behind or used in combination with various types of equipment to prepare soils for further processing.

Rippers undergo substantial wear and tear as they impact soil, and as such are a wear part that needs periodic replacement or repair. Wear coating is commonly used to reduce the amount of wear. Typically, wear coating such as tungsten carbide is slathered on the parts in a haphazard way; with the hope that the more of the surface that is covered the longer the device will last. However, this approach suffers from a number of drawbacks.

First, wear coating dulls the cutting or ripping edges thereby interfering with the ability of the ripper to cleanly and efficiently engage the soil. Additionally, wear coating placed unnecessarily is a waste of time and money, and does not end up increasing the life of the parts.

An additional factor in the effectiveness and longevity of rippers is the design and configuration of the devices. Again, prior art devices are not efficiently designed. Design features also impact the materials from which the rippers can be made, as well as the ease of manufacturing.

Accordingly, there is a need for an improved ripper that eliminates or substantially eliminates the drawbacks of the prior art.

### BRIEF DESCRIPTION OF THE FIGURES

FIG. 1 shows perspective views of a ripper.

FIG. 2 shows a top, bottom, side, front, back, and perspective views of a top cap of the ripper.

FIG. 3 shows a top bottom, side, front, and back views of the top cap.

FIG. 4 shows a top, bottom, side, front, back, and perspective views of a main body of the ripper.

FIG. 5 shows a side, bottom, and front view of the main body of the ripper.

FIG. 6 shows side, bottom, and perspective views of a bracket of the ripper.

FIG. 7 shows flat and front views a wing of the ripper.

### DETAILED DESCRIPTION OF THE INVENTION

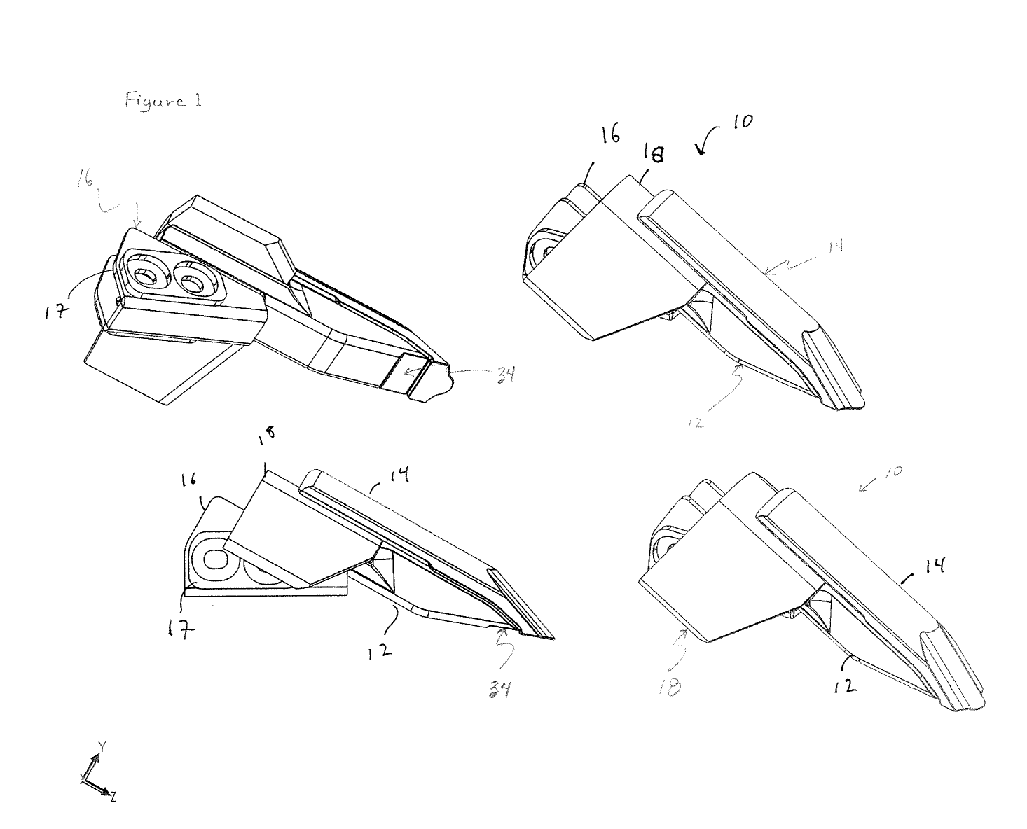

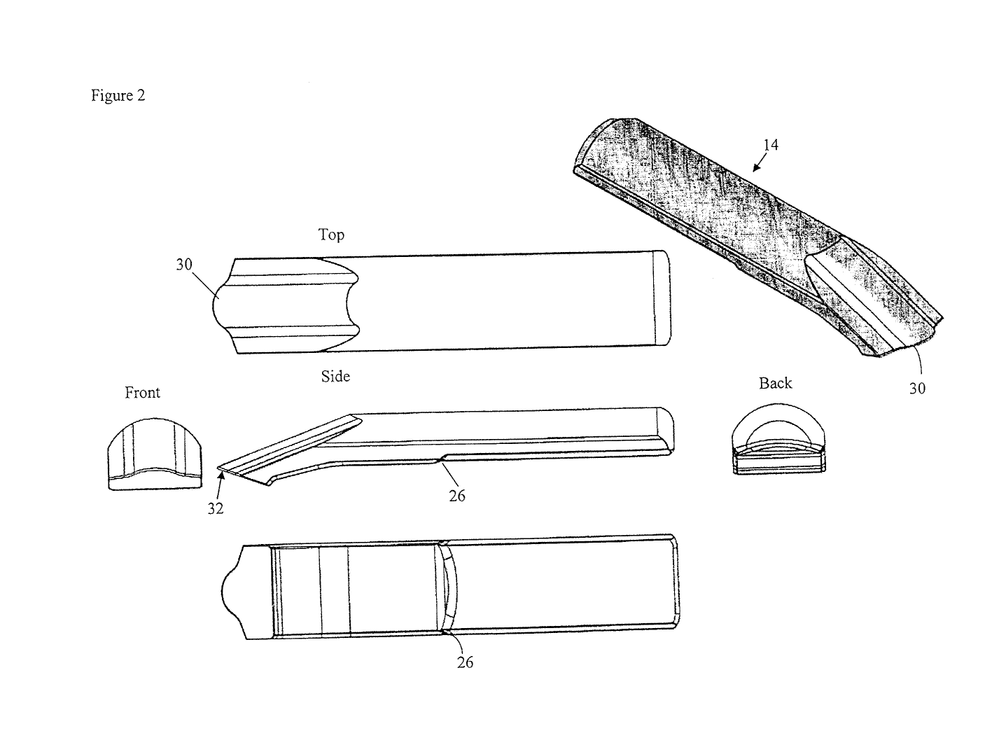

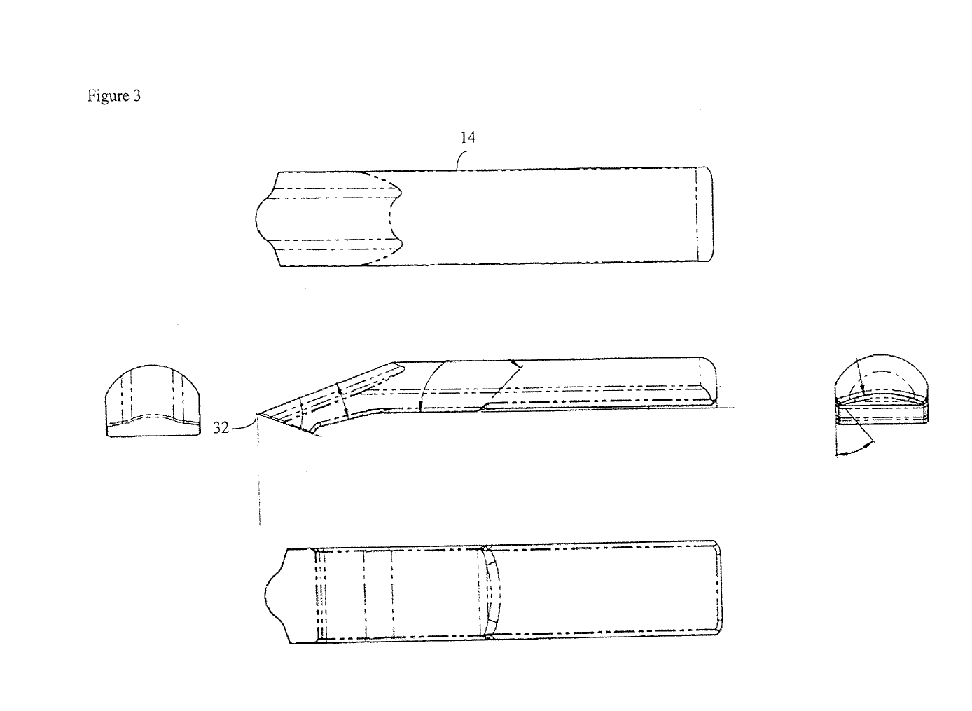

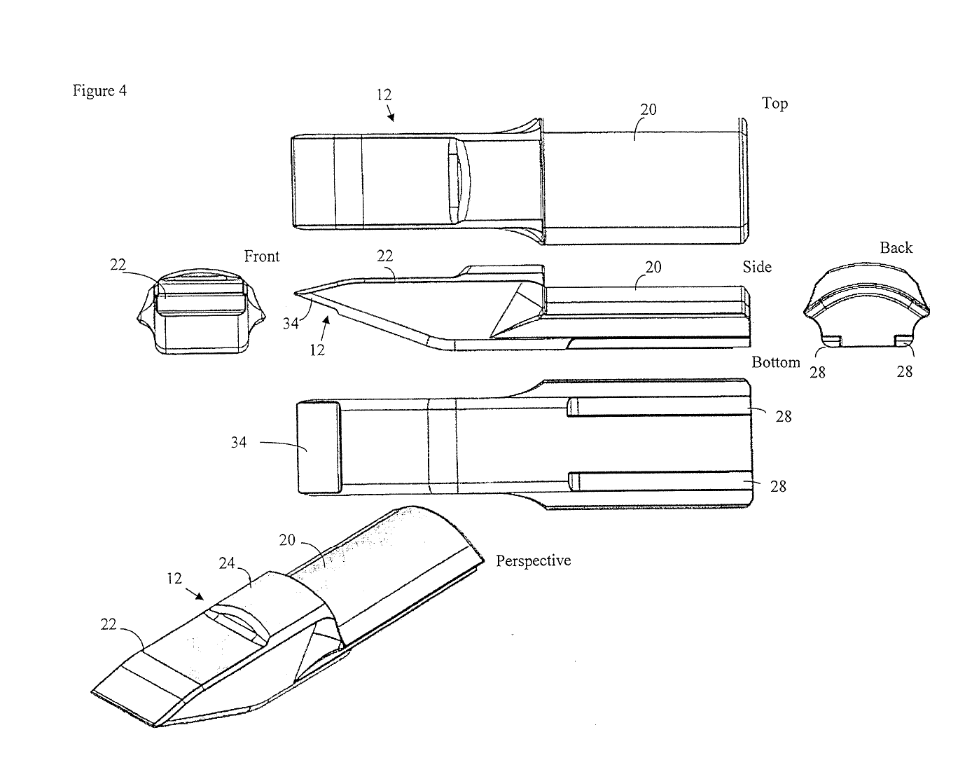

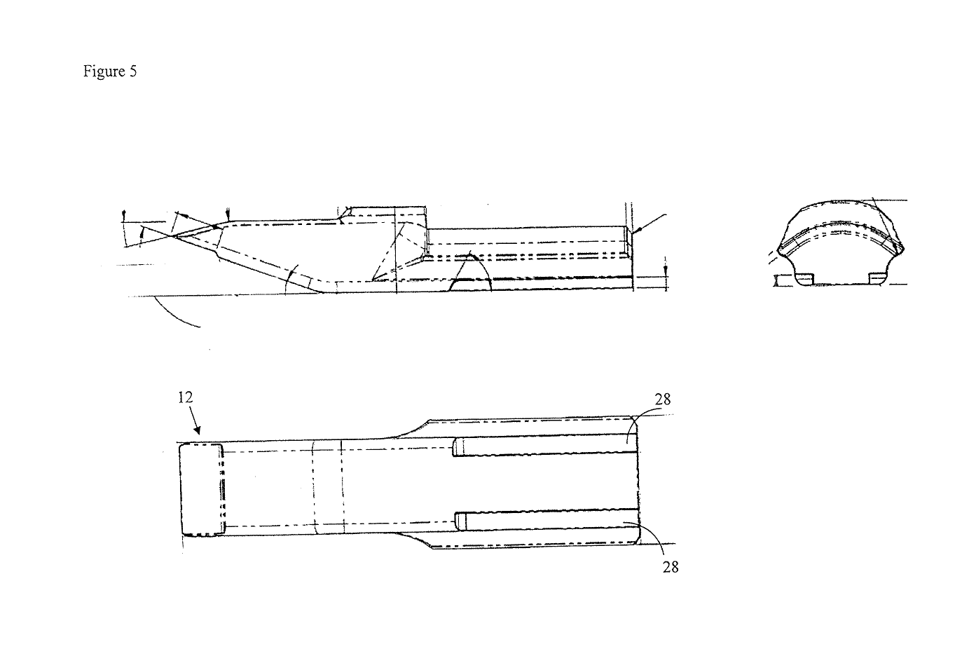

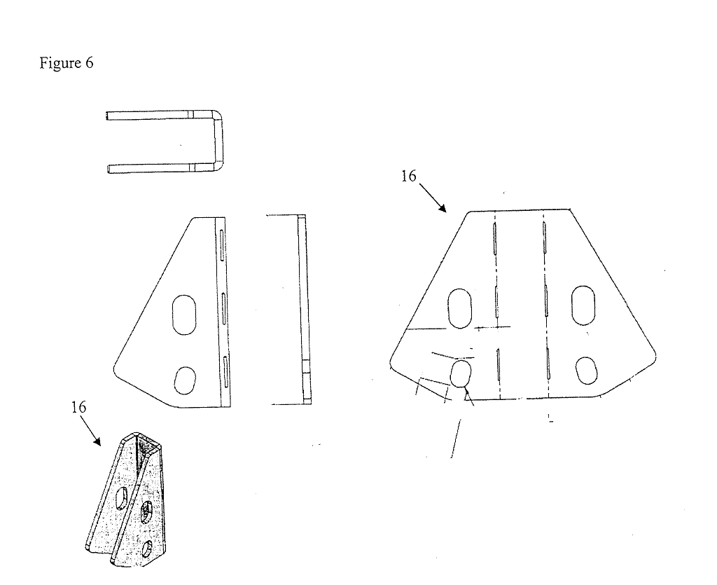

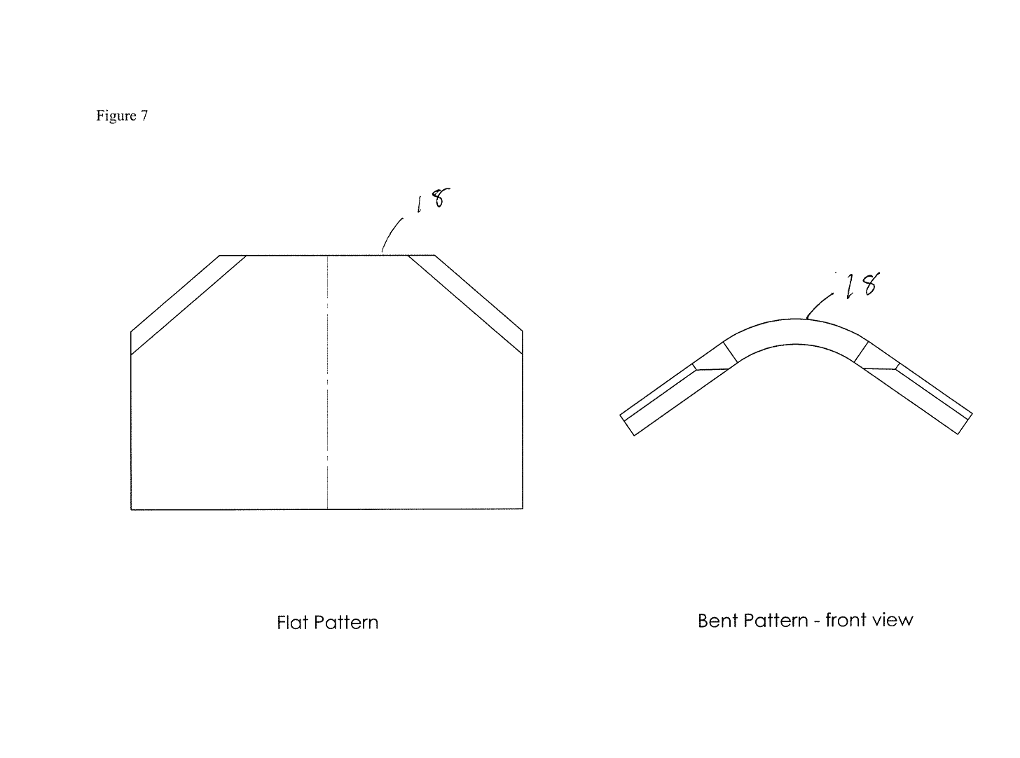

In the Figures is shown a ripper 10, which is a device used as an attachment to agricultural, construction, and industrial machines for ground engagement purposes. The ripper 10 is comprised of the following principle components; a main body 12 (shown best in FIGS. 4-5), a top cap 14 (shown best in FIGS. 2-3), a bracket 16 (shown best in FIG. 6), and a wing 18 (shown best in FIG. 7). The parts of the ripper 10 are integrated into a single device, but perform different functions therein. Multiple views of the integrated ripper 10 are shown in FIG. 1.

The main body 12 forms the core of the ripper 10 and provides space for attaching the various other parts of the ripper and includes configurations that are important to the success of the device in overcoming the problems in the prior art. In particular, the main body 12 is fabricated from heated treated alloy, or similar materials. The main body 12 includes a curved rear portion 20 for receipt of the wing 18. The curvature of the rear portion 20 allows the wings 18 to have a greater range of position and in particular, to allow the wings 18 to sweep further outward and downward. The main body 12 also includes a tapered front section 22 that is shaped to better receive the top cap 14. The main body 12 includes a shelf 24 that acts as a stop that fits into a pocket 26 on the top cap 14. This provides for a secure, repeatable, and precise placement of the top cap 14 on the main body 12. The nose of the main body is also tapered so that, along with the shelf 24, the top cap 14 and main body 12 fit in mated alignment.

The main body 12 also includes downward depending ridges 28 located on the bottom rear portion of the main body 12. The ridges 28 form a saddleback into which the bracket 16 sits. The saddleback design provides for repeatable attachment of the main body 12 to the bracket 16, and better resists rotational, twisting, and side-to-side stresses between the main body 12 and the bracket 16 when the ripper 10 is in use, which substantially reduces failure of the device. Additionally, the saddleback design allows for consistent repeatable placement of the ripper 10 on equipment by creating a uniform pocket for the bracket 16. This allows precise control of the elevation of the ripper 10 in operation on equipment.

The top cap 14 includes a tapered and rounded nose 30 that forms the impact surface of the device. This is the portion of the device that first impacts the ground, and as such undergoes the principal share of the wear. This surface is therefore typically hardened with a wear coating such as tungsten carbide to reduce wear.

The top cap 14 has rounded V-shaped profile, which creates less resistance during operation, requires less horsepower to fracture the soil, and creates a better wear angle. The rounded v-shape creates a sharper longer edge for better penetration. The effect is that the edge will stay sucked into the ground and stay there. The shorter and rounder nose of prior art devices tends to bounce out of the soil, rather than penetrate.

Unlike conventional prior art device, the present device utilizes wear coating on the back or underside of the impact surface 32. Placing the wear coating on the back, non-impact, edge of the wear part produces surprising advantages. The presence of the wear coating on the backside supports the impact front side surface from wear and better prevents wear than coating the front side. This is counter intuitive, and the prior art teaches away from such an approach. The prior art teaches putting the wear coating on the impact surface, or merely applies wear coating haphazardly to the entire part or working edge of the part without any distinction between the impact edge and the non-impact edge.

Additionally, in those situations where the sharpness of the face matters, coating the backside preserves a sharp cutting face. Coating the front side with a substance such as tungsten carbide defeats this advantage due to the fact that carbide coatings dull the face and interferes with the flow of edge through the surface it is applied to. Still further, the wear coating lasts longer on the non-impact surface since it is not in the path of abrasion as it would be with front side coating. Also, coating the backside reduces the amount of wear coating that needs to be applied in those cases where coating is applied to both sides of a wear part. These advantages are not realized if the coating is applied to the impact surface of applied generally to all surfaces.

The use of the wear coating on the backside, and as otherwise described herein, produces a lower draft as the flow of soil is not being interfered with to the extent as devices that use wear coating on the top surface. This also allows the ripper 10 to be operated at a higher speed without damage.

Wear coating is also, preferably, applied to the main body 12 at the inflection point 34 (see drawings FIGS. 1 and 4). When the ripper 10 is assembled the inflection point creates a recessed pocket behind the forward edge of the top cap 14. When the recessed pocket is filled with wear coating it becomes the lowest most exposed point of the ripper. As the lower edge of the top cap 14 wears, the wear coated inflection point 34 becomes both an impact surface and a wear surface. When wear coating is applied in this manner it provides an efficient and cost effective means of increasing the wear life of the ripper.

The bracket 16 is the point of attachment between the ripper 10 and the equipment that it is utilized with. The bracket 16 is generally U-shaped, and is attached to the underside of the main body 12 between the saddleback ridges 28 for a maximum secure fit therebetween. The bracket 16 includes holes in the sides for use to secure the bracket 16 to the equipment. The bracket 16 also includes a plate 17 attached to the bracket 16 to protect the head and nut of fasteners used to connect to the ripper 10 to equipment. The fasteners can experience residual impact from soil, debris, or stones during operation that might cause the fasteners to wear, break or come lose. The plate 17 protects against this occurrence. The bracket 16 is also shown in FIG. 6, without the plate 17.

The ripper 10 includes a wing 18. The wing 18 extends on either side of the ripper 14 and is used to create a furrow in the soil below the surface. The width of the wing 18 will vary depending on the application. Typical widths for the wing 18 are 5″, 7″, and 10″. Longer width displaces more soil, vary the turbulence and distribution of soil, and break up clods. In some circumstances, a wing is not needed, and a blank would be inserted to fill the gap between the top cap 14 and the main body 12. Wear coating can be placed on the bottom side of the edge of the wing 18 to protect the part from wear in the same manner as described above. The coating on the bottom, as mentioned, protects the wing 18 but does not interrupt the flow of material over the top of the part and allows for use with little resistance.

The wing 18 may also include a vertical fin (pointing down or up) that can be attached to each end of the wing, this would aid in breaking up clogs of dirt.

The main body 12 is preferably made of hardened alloy steel, the top cap 14 is preferably made from a high wear resistant casting, and the bracket 18 is preferably made from mild steel. The wings 18 are preferably made from hardened alloy plate. Other materials can be substituted depending on the circumstances.

These and other advantages will be apparent to those of ordinary skill in the art.

While the various embodiments of the invention have been described in reference to the Figures, the invention is not so limited. Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A ripper for engagement with the ground, comprising:
a main body having a saddle back cavity; and
a top cap secured to the top of the main body having an impact edge.

2. The ripper of claim 1 further comprising two opposing shoulder-sections with a recessed section therebetween forming the saddle-back on the bottom of the main body.

3. The ripper of claim 2 further comprising a bracket secured between the two opposing shoulder sections.

4. The ripper of claim 3 where the bracket has holes adapted to allow the ripper to be relesably secured to other equipment.

5. The ripper of claim 1 further comprising a wing secured between the top cap and the main body.

6. The ripper of claim 5 where the top of the main body is curved along a transverse axis at the point of attachment to the wing, and the wing is correspondingly curved.

7. The ripper of claim 5 where the main body has a shelf and a recessed front section to form a point of securement with a ridge on the bottom of the top cap that contacts the shelf.

8. The ripper of claim 1 where the top cap has an elongated rounded protrusion on the top front that terminates in the impact edge.

9. The ripper of claim 1 where the main body has an inflection point or recessed pocket at the bottom front that can become a wear surface.

10. The ripper of claim 9 where the inflection point or recessed pocket is covered/filled with wear coating.

11. The ripper of claim 10 where the wear coating comprises tungsten carbide.

12. The ripper of claim 8 where the impact edge is covered with a wear coating.

13. The ripper of claim 8 where the only the bottom of the impact edge is covered with a wear coating.

14. The ripper of claim 13 where the wear coating comprises tungsten carbide.

15. The ripper of claim 5 where the wing further comprises a vertical fin.

16. The ripper of claim 15 where the fin extends downward.

17. The ripper of claim 15 where the fin extends upward.

18. The ripper of claim 1 where a blank is placed between the top cap and the body.

19. The ripper of claim 4 where the bracket further comprises a plate adapted to protect fasteners used to connect the ripper to equipment.

20. The ripper of claim 1 where the main body has a recessed pocket behind a forward edge of the top cap.

21. A for engagement with the ground, comprising:
a main body having a saddle back cavity comprising two opposing shoulder-sections with a recessed section therebetween on the bottom of the main body, and where the main body has an inflection point at the bottom front that can become a wear surface;
a bracket having holes adapted to allow the ripper to be relesably secured to other equipment, the bracket secured between the two opposing shoulder sections of the main body, the bracket also comprising a plate adapted to protect fasteners used to connect the ripper to equipment;
a top cap secured to the top of the main body having an impact edge and where the main body has a shelf and a recessed front section to form a point of securement with a ridge on bottom of the top cap that contacts the shelf, and the top cap has an elongated rounded protrusion on the top front that terminates in the impact edge, and where a forward edge of the top cap creates a recessed pocket in the main body;
a wing secured between the top cap and the main body where the top of the main body is curved along a transverse axis at the point of attachment to the wing, and the wing is correspondingly curved, and the wing further comprises a vertical fin; and
where the inflection point of the main body and only the bottom of the impact edge of the top cap are covered with tungsten carbide.
